(19) United States
(12) Patent Application Publication
(10) Pub. No.: US 2006/0193462 A1
(43) Pub. Date: Aug. 31, 2006

(54) System for optimizing configurable information handling systems

(76) Inventor: Gregg Hansen, Austin, TX (US)

Correspondence Address: HAMILTON & TERRILE, LLP, P.O. BOX 203518, AUSTIN, TX, 78720, US

(21) Appl. No.: 11/068,111

(22) Filed: Feb. 28, 2005

(51) Int. Cl. H04M 3/00

(52) U.S. Cl. 379/266.01

(57) ABSTRACT

In one embodiment, the invention relates to a method for automatically optimizing configuration of an information handling system based upon predefined goals which include providing the predefined goals to a configurator, performing a needs based optimization based upon the predefined goals and indicating a preferred information handling system configuration based upon the needs based optimization.

### BACKGROUND OF THE INVENTION

1. Field of the Invention

The present invention relates to configuring information handling systems, and more particularly, automatically optimizing the configuration of information handling systems based upon certain criteria.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One issue relating to information handling system suppliers is how to optimize a system based upon customer provided criteria. For example, referring to FIG. 1, labeled prior art, when a customer is configuring a system either via an on-line configurator or via a customer service representative, often the customer has certain criteria that the customer wishes the information handling system to address. Known configurators often provide an iterative approach to configuring a system. For example, a customer or a customer service representative might identify a system at step 110, next options are selected for the system at step 112. The customer service representative often then reviews the system to determine the profit margin associated with the system order at step 114. If the margin is not within a desired goal, then the customer service representative might look for higher margin items at step 116 and then review possible choices with the customer at step 118. Once the margin for the system order meets a desired goal, then the customer service representative would review the system with the customer at step 120 to obtain the customer's approval to order the system (i.e., to close the sale). Such a system of iteratively modifying a system can be time consuming, dependent on the skill of the customer service representative and not a dependable method for producing the highest margin, best customer configuration for a particular set of criteria.

### SUMMARY OF THE INVENTION

In accordance with the present invention, a system which automatically optimizes an information handling system configuration based upon predefined goals and customer provided criteria is disclosed.

In one embodiment, the invention relates to a method for automatically optimizing configuration of an information handling system based upon predefined goals which include providing the predefined goals to a configurator, performing a needs based optimization based upon the predefined goals and indicating a preferred information handling system configuration based upon the needs based optimization.

In another embodiment, the invention relates to an apparatus for automatically optimizing configuration of an information handling system based upon predefined goals which includes means for providing the predefined goals to a configurator, mean for performing a needs based optimization based upon the predefined goals, and means for indicating a preferred information handling system configuration based upon the needs based optimization.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1, labeled prior art, shows a flow diagram of the operation of a system for configuring an information handling system.

FIG. 2 shows an overview block diagram representation of an information handling system commerce application.

FIG. 3 shows access to the on-line store via the Internet using a computer system.

FIG. 4 shows a system block diagram of an information handling system.

FIG. 5 shows a flow diagram of the operation of a system for configuring an information handling system that includes an optimization module.

FIG. 6 shows a flow diagram of the operation of the optimization module.

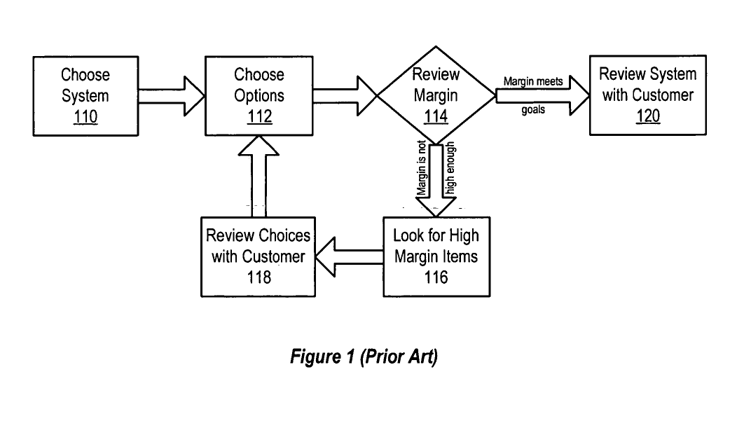

### DETAILED DESCRIPTION

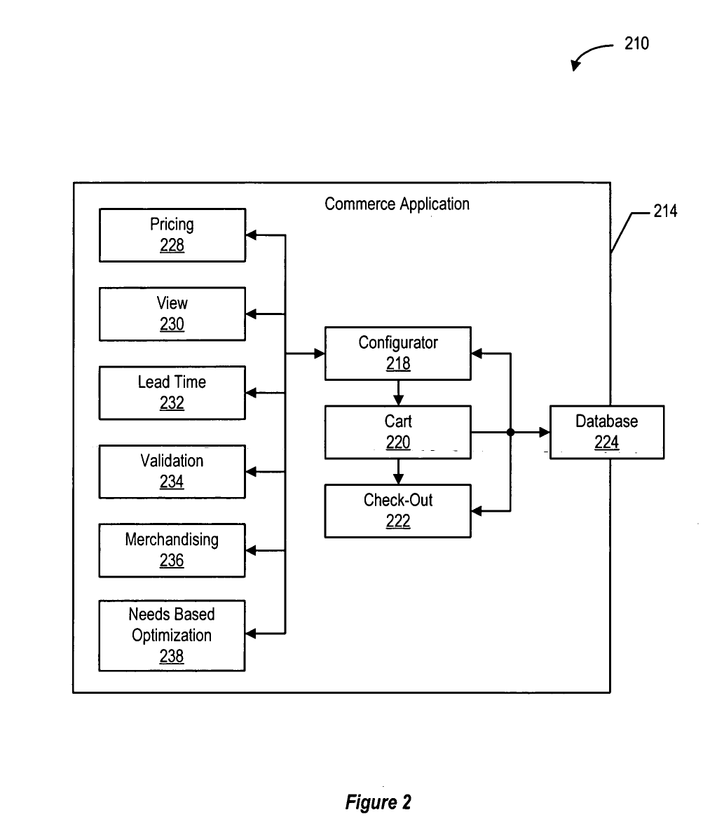

Referring now to FIG. 2, a commerce application 214 for use in configuring information handling systems, e.g., computer systems, is shown. The commerce application 214 includes a configurator 218, shopping cart 220, a checkout module 222 and database 224. The database 224 provides information to the configurator 218, shopping cart 220, and checkout module 222. The configurator 218 includes a pricing module 228, a view module 230, a lead time warning module 232, a validation (or compatibility) warning module 234, a merchandising module 236 and a needs based optimization module 238. The various modules of the configurator 218 are driven by data from the database 224, and thus the configurator 218, shopping cart 220, and checkout module 222 are all linked to the database 224.

Aspects of the configurator 218 which interact with database 224 are shown in FIG. 2. In essence, the entire commerce application 214 interacts with the database. The configurator 218, shopping cart 220, and checkout module 222 are each part of the commerce application 214 and interact with the database 224. For example, with the shopping cart 220, additional merchandising information associated with a particular system which has been configured and placed in the shopping cart by an on-line store customer can be provided.

The needs based optimization module automatically optimizes an information handling system configuration based upon predefined goals as well as customer provided criteria.

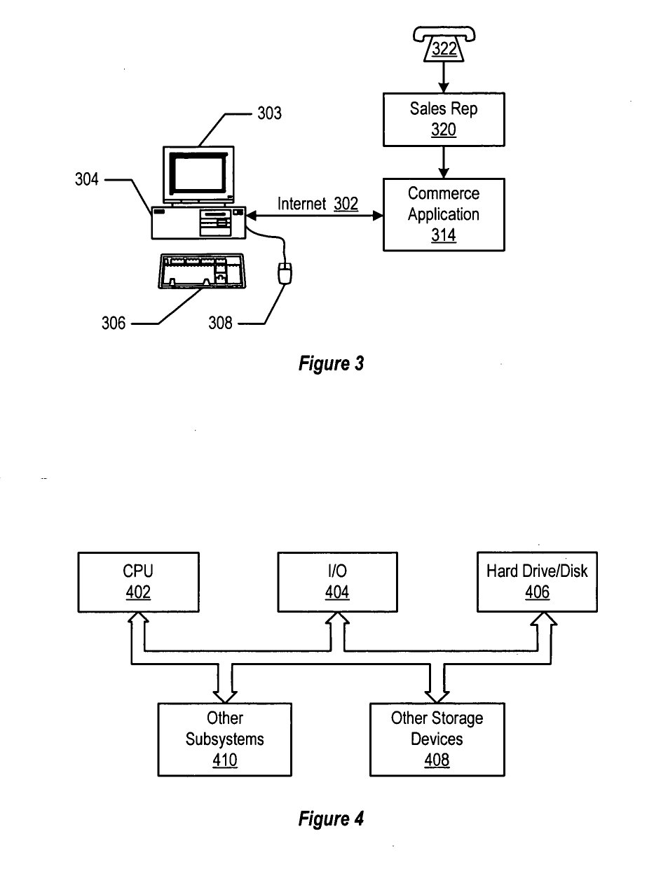

Referring to FIG. 3, a customer can access the commerce application 214 using any suitable computer equipment 300, via the Internet 302. The computer equipment 140 may include a display 303, computer 304, keyboard 306, and pointing device 308. Display 303 is used for displaying the various pages of the on-line store while a customer is using the on-line store. Alternately, the commerce application 214 may be accessed via a sales representative 320. A customer interacts with the sales representative 320 via, for example, a telephone 322. The sales representative in turn uses the commerce application 314 to configure an information handling system.

Referring briefly to FIG. 4, a system block diagram of an information handling system 400 is shown having features configured in accordance with the commerce application 214. The information handling system 400 includes a processor 402, input/output (I/O) devices 404, such as a display, a keyboard, a mouse, and associated controllers, a hard disk drive 406, and other storage devices 408, such as a floppy disk and drive and other memory devices, and various other subsystems 410, all interconnected via one or more buses, shown collectively as a bus 412.

For purposes of this invention, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

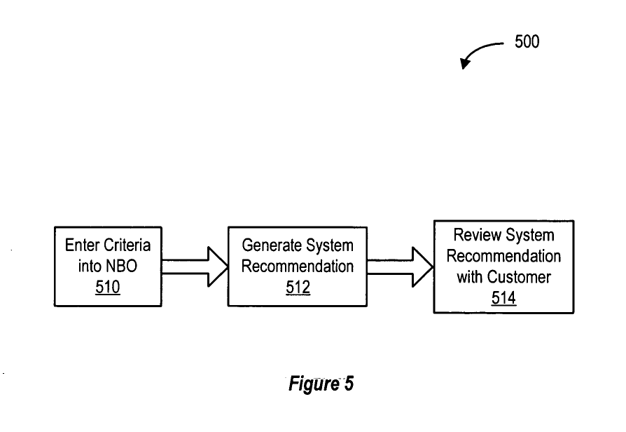

Referring to FIG. 5, a flow diagram of the operation of a system 500 for automatically configuring an information handling system that includes a needs based optimization module is shown. More specifically, the system 500 for automatically configuring an information handling system uses multiple data sources about a customer to automatically determine an optimal configuration for an information handling system recommendation based upon predefined goals. The predefined goals may include maximizing system profit margin.

The system 500 may function solely with a system budget number provided by the customer. However, the quality of the system recommendation increases with the addition of more customer specific information such as marketing segmentation information (e.g., home user, small business user, large enterprise user), customer profile information (e.g., the type of system use such as a game system or a video processing system, or a customer's credit information), customer preference information (such as a customer's desire for the system to include a particular type of component) or customer demographic data. Increasing the quality of a recommendation increases the close rates of the system for automatically configuring an information handling system.

In operation, a sales representative enters the customer's estimated or requested budget into the optimization module at step 510. The additional customer specific information may also be entered at step 510. The optimized configuration for a system is then generated by the optimization module at step 512. The system recommendation is then reviewed with the customer at step 514. Because the sale representative uses any call flow model required to reach the configuration, the margin optimization takes very little additional time to reach the maximum optimal configuration. Thus, the system maximizes margin without impacting average handle time.

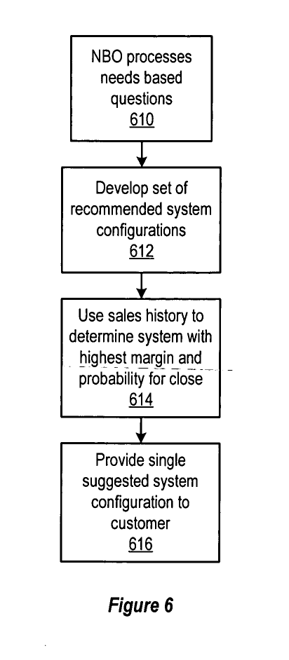

Referring to FIG. 6, a flow diagram of the operation of the needs based optimization module is shown. More specifically, the needs based optimization module 238 starts operating by processing the input from needs based questions at step 610. The needs based optimization module 238 then develops a set of recommended system configurations based upon the answers to the needs based questions at step 612. The needs based optimization module 238 then uses sales history information to determine a system that provides the highest profit margin as well as the highest probability of closing a sale at step 614. This system is then provided as the single suggested system configuration to the sales representative at step 616.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Also for example, the needs based offer engine can include a plurality of other functions. For example, the needs based offer engine might include the ability to move a recommendation up or down price bands. Because customers sometimes start at the wrong price band, this option enables a customer service representative to continue using the needs based offer engine after the price band is adjusted. This option would also allow a customer service representative to continue using the needs based offer engine even if the customer service representative upsells a product into a higher priceband.

Also for example, the system 500 for automatically configuring an information handling system may be used by technical service representatives as well as customer service representatives. When a call comes in to a technical service representative for a service problem with a particular system, the technical service representative may access the commerce application to provide the customer with an option of purchasing a new system rather than repairing the older system for which the service was requested. In this example, the customer provided budget might be the cost of repairing the older system. Additionally, the system 500 for automatically configuring an information handling system can identify criteria about the old system to assure that the new configuration has similar criteria (e.g., if the old system has a large hard drive, than the new system configuration would include at least as large a hard drive).

Consequently, the invention is intended to be limited only by the spirit and scope of the appended claims, giving full cognizance to equivalents in all respects.

What is claimed is:

1. A method for automatically optimizing configuration of an information handling system based upon predefined goals comprising:
providing the predefined goals to a configurator;
performing a needs based optimization based upon the predefined goals;
indicating a preferred information handling system configuration based upon the needs based optimization.

2. The method of claim 1 wherein:
the predefined goals include identifying margins associated with various information handling system configurations.

3. The method of claim 1 wherein:
the needs based optimization is preformed using customer provided information.

4. The method of claim 3 wherein:
the customer provided information includes a preferred budget for the information handling system.

5. The method of claim 3 wherein:
the customer provided information includes at least one of customer marketing segmentation information, customer profile information , customer preference information and customer demographic data.

6. The method of claim 1 wherein:
the optimizing configuration the information handling system is in response to a technical service contact.

7. The method of claim 6 wherein:
the needs based optimization is preformed using a cost of repairing an information handling system.

8. The method of claim 6 wherein:
the needs based optimization takes into account a configuration of a system for which the technical service contact was initiated.

9. The method of claim 1 wherein:
the needs based optimization is preformed using customer provided budget information; and,
the budget information may be may be adjusted across price bands after the needs based optimization is performed.

10. An apparatus for automatically optimizing configuration of an information handling system based upon predefined goals comprising:
means for providing the predefined goals to a configurator;
mean for performing a needs based optimization based upon the predefined goals;
means for indicating a preferred information handling system configuration based upon the needs based optimization.

11. The apparatus of claim 10 wherein:
the predefined goals include identifying margins associated with various information handling system configurations.

12. The apparatus of claim 10 wherein:
the needs based optimization is preformed using customer provided information.

13. The apparatus of claim 12 wherein:
the customer provided information includes a preferred budget for the information handling system.

14. The apparatus of claim 12 wherein:
the customer provided information includes at least one of customer marketing segmentation information, customer profile information , customer preference information and customer demographic data.

15. The apparatus of claim 10 wherein:
the optimizing configuration the information handling system is in response to a technical service contact.

16. The apparatus of claim 15 wherein:
the needs based optimization is preformed using a cost of repairing an information handling system.

17. The apparatus of claim 16 wherein:
the needs based optimization takes into account a configuration of a system for which the technical service contact was initiated.

18. The apparatus of claim 10 wherein:
the needs based optimization is preformed using customer provided budget information; and,
the budget information may be may be adjusted across price bands after the needs based optimization is performed.
